(19) United States
(12) Patent Application Publication
(10) Pub. No.: US 2005/0022362 A1
(43) Pub. Date: Feb. 3, 2005

(54) Method for making a composite tool

(75) Inventor: Ching-Hung Chen, Tainan (TW)

Correspondence Address: LADAS & PARRY, 26 West 61st Street, New York, NY, 10023-7604, US

(73) Assignee: SAN SHING FASTECH CORP.

(21) Appl. No.: 10/632,938

(22) Filed: Aug. 1, 2003

(51) Int. Cl. B21D 39/03; B23P 11/00; B23K 1/20

(52) U.S. Cl. 29/521; 29/522.1; 228/173.2

(57) ABSTRACT

A method for making a composite tool includes the steps of forming a recess in one of a steel shank and a working body, forming a protrusion on the other of the steel shank and the working body, pressing the protrusion into the recess in such a manner that the protrusion completely fills the recess, and forming a solder joint on a shoulder defined by the steel shank and the working body.

### BACKGROUND OF THE INVENTION

1. Field of the Invention

This invention relates to a method for making a composite tool, more particularly to a method for making a composite tool having a steel shank and a working head connected to the steel shank and made from tungsten carbide.

2. Description of the Related Art

U.S. Pat. No. 3,677,060 discloses a composite tool that includes a steel shank and a working body made from a metal carbide. The composite tool is formed by forming a cylindrical recess in the steel shank, forming a cylindrical protrusion, which has a diameter smaller than that of the recess, on the working body, inserting the protrusion into the recess to define a clearance between the protrusion and the steel shank, applying a brazing material in the clearance, heating the brazing material in the clearance to a temperature above the melting point of the brazing material, and cooling the steel shank to form a brazed joint in the clearance.

U.S. Pat. No. 4,772,125 discloses a composite tool (see FIG. 1) that includes a steel shank 11 and a working body 12 connected to the steel shank 11 and made from a metal carbide. The composite tool is formed by forming a crown-like recess 13, which has an enlarged segment 131, in the working body 12, forming a cylindrical protrusion 14, which has a diameter smaller than that of the enlarged segment 131 of the recess 13, on the steel shank 11, inserting the protrusion 14 into the recess 13 to define a clearance between the protrusion 14 and the working body 12, applying a brazing material in the clearance, heating the brazing material to a temperature higher than the melting point of the brazing material, and cooling the steel shank 11 to form a brazed joint 15 in the clearance. The recess 13 further has a basin that cooperates with the protrusion 14 to define a cavity 16 therebetween. Note that the cavity 16 is not filled with the brazing material.

The aforesaid conventional methods for making the composite tool are disadvantageous in that a brazing material is required for forming a brazed joint to connect the steel shank to the working body and to enhance durability of the tool. Moreover, formation of the crown-like recess 13 in the working body 12 is relatively difficult to conduct due to the hardness of the metal carbide.

The disclosures of the aforesaid U.S. patents are incorporated herein by reference.

### SUMMARY OF THE INVENTION

Therefore, it is an object of the present invention to provide a method for making a composite tool that is capable of overcoming the aforesaid disadvantages of the prior art.

According to one aspect of the present invention, there is provided a method for making a composite tool that includes a steel shank and a working body that is connected to the steel shank and that is made from a metal carbide. The method comprises the steps of: (a) forming a recess in the working head such that the recess is indented inwardly from a first joint face of the working head in a transverse direction relative to the first joint face, the recess having a cylindrical section that extends in the transverse direction and that is distal from the first joint face, and a skirt section that flares outwardly from the cylindrical section to the first joint face and that has an outer edge adjacent to the first joint face; (b) forming a cylindrical protrusion on a second joint face of the steel shank such that the cylindrical protrusion has a diameter greater than that of the cylindrical section of the recess and smaller than that of the outer edge of the skirt section of the recess; (c) inserting the cylindrical protrusion of the steel shank into the recess in the working head and pressing the steel shank and the working head against each other in such a manner that the cylindrical protrusion is deformed to completely fill the recess, that the first and second joint faces abut against each other to define a contact region therebetween, and that the working head and the steel shank cooperatively define a shoulder around the contact region, the shoulder defining a corner adjacent to the contact region; and (d) forming a solder joint on the corner by welding techniques.

According to another aspect of the present invention, there is provided a method for making a composite tool that includes a steel shank and a working body that is connected to the steel shank and that is made from a metal carbide. The method comprises the steps of: (a) forming a generally conical recess in the steel shank such that the recess is indented inwardly from a first joint face of the steel shank in a transverse direction relative to the first joint face, the recess having a depth in the transverse direction; (b) forming a generally conical protrusion on a second joint face of the working head such that the conical protrusion has dimensions respectively proportional to those of the recess, and a height, which is measured from a vertex of the conical protrusion to the second joint face, greater than the depth of the recess; (c) inserting the conical protrusion of the working head into the recess in the steel shank and pressing the steel shank and the working head against each other in such a manner that the conical recess is enlarged by the conical protrusion, that the conical protrusion completely fills the conical recess, that the first and second joint faces abut against each other to define a contact region therebetween, and that the working head and the steel shank cooperatively define a shoulder around the contact region, the shoulder defining a corner adjacent to the contact region; and (d) forming a solder joint on the corner by welding.

### BRIEF DESCRIPTION OF THE DRAWINGS

In drawings which illustrate embodiments of the invention,

FIG. 1 is a sectional view of a composite tool formed according to a conventional method;

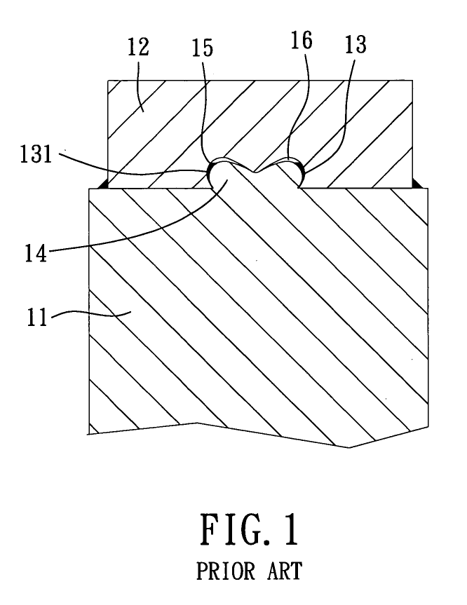

FIG. 2 is a flow diagram to illustrate consecutive steps of the first preferred embodiment of a method of this invention for making a composite tool;

FIG. 3 is a sectional view illustrating the configurations of a working body of a metal carbide and a steel shank of the composite tool before the working body and the steel shank are joined together according to the first preferred embodiment;

FIG. 4 is a sectional view illustrating the configuration of the composite tool after the working body and the steel shank are joined together according to the first preferred embodiment;

FIG. 5 is a sectional view illustrating the configurations of the working body and the steel shank of the composite tool before the working body and the steel shank are joined together according to the second preferred embodiment; and

FIG. 6 is a sectional view illustrating the configuration of the composite tool after the working body and the steel shank are joined together according to the second preferred embodiment.

### DETAILED DESCRIPTION OF THE PREFERRED EMBODIMENTS

For the sake of brevity, like elements are denoted by the same reference numerals throughout the disclosure.

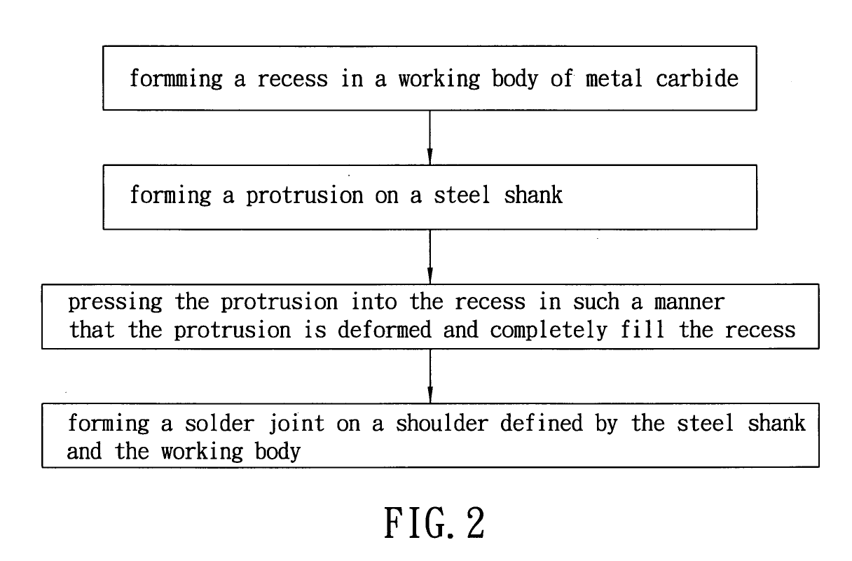

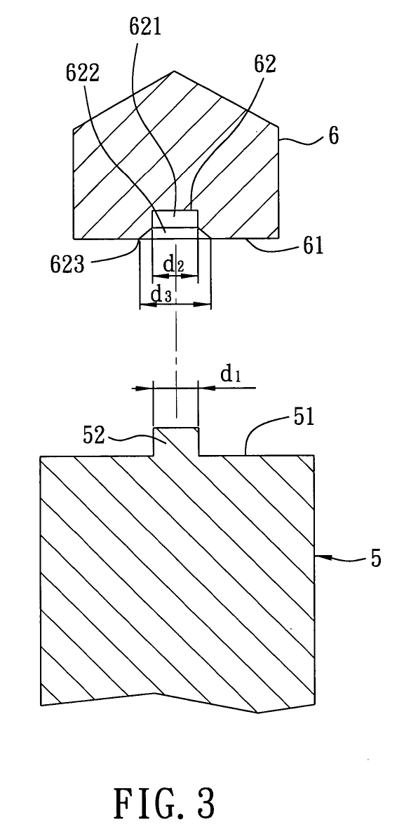

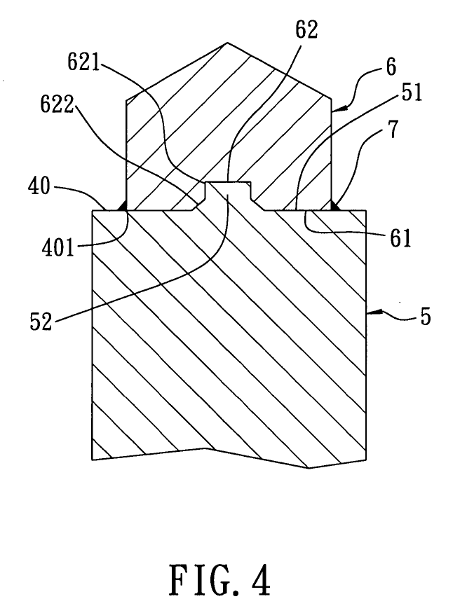

FIG. 2 illustrates a flow diagram of the first preferred embodiment of a method of this invention for making a composite tool (see FIG. 4) that includes a steel shank 5 and a working body 6 that is connected to the steel shank 5 and that is made from metal carbide, such as tungsten carbide. The method of this invention includes the steps of: (a) forming a recess 62 in the working head 6 (see FIG. 3) such that the recess 62 is indented inwardly from a first joint face 61 of the working head 6 in a transverse direction relative to the first joint face 61, the recess 62 having a cylindrical section 621 that extends in the transverse direction and that is distal from the first joint face 61, and a skirt section 622 that flares outwardly from the cylindrical section 621 to the first joint face 61 and that has an outer edge 623 adjacent to the first joint face 61; (b) forming a cylindrical protrusion 52 on a second joint face 51 of the steel shank 5 such that the cylindrical protrusion 52 has a diameter (d₁) greater than that (d₂) of the cylindrical section 621 of the recess 62 and smaller than that (d₃) of the outer edge 623 of the skirt section 622 of the recess 62; (c) inserting the cylindrical protrusion 52 of the steel shank 5 into the recess 62 in the working head 6 and pressing the steel shank 5 and the working head 6 against each other in such a manner that the cylindrical protrusion 52 is deformed to completely fill the recess 62, that the first and second joint faces 61, 51 abut against each other to define a contact region therebetween, and that the working head 6 and the steel shank 5 cooperatively define a shoulder 40 around the contact region, the shoulder 40 defining a corner 401 adjacent to the contact region; and (d) forming a solder joint 7 on the corner 401 using conventional welding techniques. Preferably, the solder joint 7 is formed by applying a solder material on the corner 401 of the shoulder 40, subsequently heating the assembly of the steel shank 5 and the working body 6 to a temperature higher than the melting point of the solder material under vacuum conditions so as to melt the solder material, and cooling the assembly in a cooling chamber so as to form the solder joint 7.

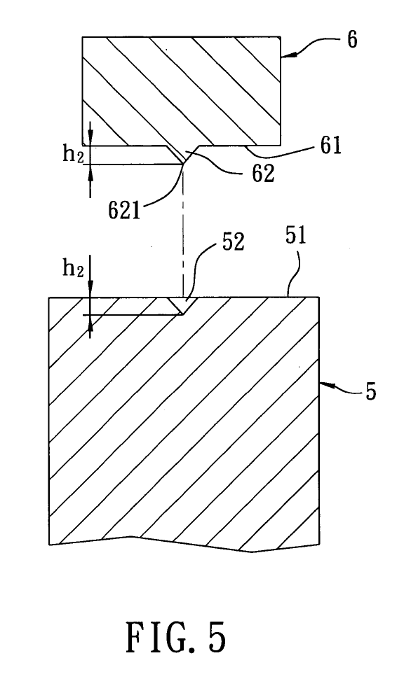

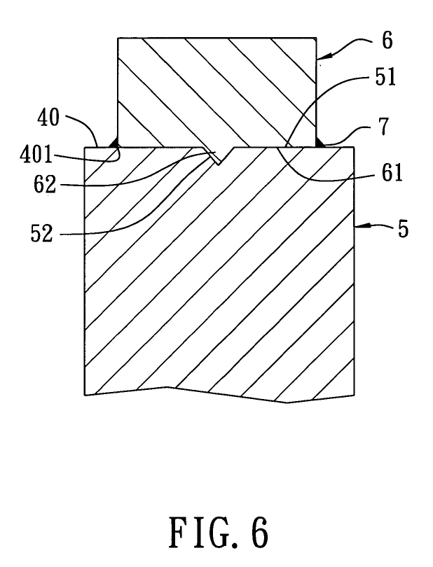

FIGS. 5 and 6 illustrate the shapes of a steel shank 5 and a working body 6 of a composite tool that is formed according to the second preferred embodiment of the method of this invention.

The method of this embodiment is a modification of the previous embodiment, and includes the steps of: (a) forming a generally conical recess 52 in the steel shank 5 such that the recess 52 is indented inwardly from a first joint face 51 of the steel shank 5 in a transverse direction relative to the first joint face 51, the recess 52 having a depth (h₁) in the transverse direction; (b) forming a generally conical protrusion 62 on a second joint face 61 of the working head 6 such that the conical protrusion 62 has dimensions respectively proportional to those of the recess 52, and a height (h₂), which is measured from a vertex 621 of the conical protrusion 62 to the second joint face 61, greater than the depth (h₁) of the recess 52; (c) inserting the conical protrusion 62 of the working head 6 into the recess 52 in the steel shank 5 and pressing the steel shank 5 and the working head 6 against each other in such a manner that the conical recess 52 is enlarged by the conical protrusion 62, that the conical protrusion 62 completely fills the conical recess 52, that the first and second joint faces 51, 61 abut against each other to define a contact region therebetween, and that the working head 6 and the steel shank 5 cooperatively define a shoulder 40 around the contact region, the shoulder 40 defining a corner 401 adjacent to the contact region; and (d) forming a solder joint 7 on the corner 401 using conventional welding techniques.

Since the aforesaid protrusion of the first embodiment or the second embodiment of the present invention completely fills the recess and does not form the clearance taught in the conventional methods, the step of using brazing material to form a brazed joint between the steel shank and the working body can be eliminated.

With the invention thus explained, it is apparent that various modifications and variations can be made without departing from the spirit of the present invention. It is therefore intended that the invention be limited only as recited in the appended claims.

1. A method for making a composite tool having a steel shank and a working head that is connected to the steel shank and that is made from metal carbide, the method comprising the steps of:
(a) forming a recess in the working head such that the recess is indented inwardly from a first joint face of the working head in a transverse direction relative to the first joint face, the recess having a cylindrical section that extends in the transverse direction and that is distal from the first joint face, and a skirt section that flares outwardly from the cylindrical section to the first joint face and that has an outer edge adjacent to the first joint face;
(b) forming a cylindrical protrusion on a second joint face of the steel shank such that the cylindrical protrusion has a diameter greater than that of the cylindrical section of the recess and smaller than that of the outer edge of the skirt section of the recess;
(c) inserting the cylindrical protrusion of the steel shank into the recess in the working head and pressing the steel shank and the working head against each other in such a manner that the cylindrical protrusion is deformed to completely fill the recess, that the first and second joint faces abut against each other to define a contact region therebetween, and that the working head and the steel shank cooperatively define a shoulder around the contact region, the shoulder defining a corner adjacent to the contact region; and
(d) forming a solder joint on the corner by welding.

2. The method of claim 1, wherein the solder joint is formed by applying a solder material on the corner of the shoulder and subsequently melting the solder material under vacuum conditions.

3. A method for making a composite tool having a steel shank and a working head that is connected to the steel shank and that is made from metal carbide, the method comprising the steps of:
(a) forming a generally conical recess in the steel shank such that the recess is indented inwardly from a first joint face of the steel shank in a transverse direction relative to the first joint face, the recess having a depth in the transverse direction;
(b) forming a generally conical protrusion on a second joint face of the working head such that the conical protrusion has dimensions respectively proportional to those of the recess, and a height, which is measured from a vertex of the conical protrusion to the second joint face, greater than the depth of the recess;
(c) inserting the conical protrusion of the working head into the recess in the steel shank and pressing the steel shank and the working head against each other in such a manner that the conical recess is enlarged by the conical protrusion, that the conical protrusion completely fills the recess, that the first and second joint faces abut against each other to define a contact region therebetween, and that the working head and the steel shank cooperatively define a shoulder around the contact region, the shoulder defining a corner adjacent to the contact region; and
(d) forming a solder joint on the corner by welding.
